(19) United States
(12) Patent Application Publication
(10) Pub. No.: US 2023/0065548 A1
(43) Pub. Date: Mar. 2, 2023

(54) STEAMER FOR FOOD REHYDRATION

(71) Applicant: Mezli, Inc., San Mateo, CA (US)

(72) Inventors: Alexander Makris Gruebele, Menlo Park, CA (US); Maxwell Emerald Perham, Palo Alto, CA (US); Yuri Alexandrovich Kolchinski, San Francisco, CA (US)

(21) Appl. No.: 17/900,791

(22) Filed: Aug. 31, 2022

Related U.S. Application Data
(60) Provisional application No. 63/240,005, filed on Sep. 2, 2021.

(51) Int. Cl. A23L 5/00; A23L 5/10

(52) U.S. Cl. CPC A23L 5/55; A23L 5/13; G07F 17/0078

(57) ABSTRACT

A system for rehydrating a food item includes a housing, a casing, an actuator, a moisture source, and a plate. The moisture source includes an outlet and an enclosed vessel having liquid. The liquid is released by steam or pressure as moisture into a first end of a conduit. The system has a plate with a top surface, a bottom surface and an opening traversing between the two. A casing couples with the top surface of the plate. The second end of the conduit couples with the opening. The casing has a pivot point. An actuator couples the casing on a first end and the housing at a second end. The actuator moves the casing from a first position to a second position by rotation about the pivot point. In the first position, the moisture flows towards the plate and in the second position moisture flow is idled.

### CROSS REFERENCE TO RELATED APPLICATIONS

This application is related to provisional application 63/240,005, filed Sep. 2, 2021, the contents of which are incorporated by reference herein.

### TECHNICAL FIELD

The disclosed embodiments generally relate to automated food preparation, and particularly to food rehydration systems.

### BACKGROUND

A challenge with automated vending type food preparation systems is application of liquid to rehydrate, cook and otherwise prepare food items. Conventional systems often require specialized structures or containers within which the food is mixed and then transferred to the serving vessel. This increases processing complexity and waste as additional resources for cleaning are required.

### SUMMARY

A system for steaming food items to hydrate them is described herein. The steamer discussed may be part of a hot food vending set up and interact with other components of the vending system such as food item dispensers, heating elements, or refrigeration elements. The steamer may be used to rehydrate, cook, or otherwise prepare food items.

In some embodiments the steamer consists of a steam outlet coupled to a plate. The plate is actuated to cover a bowl containing a food item and seals the steam in. The steamer is instructed by an external system to dispense steam at a determined rate, temperature, pressure, or pattern based on the food item.

### BRIEF DESCRIPTION OF THE DRAWINGS

FIG. 1 is a system environment in which the steamer operates in accordance with some embodiments.

FIG. 2 is a block diagram illustrating the components of a food preparation unit in accordance with some embodiments.

FIG. 3 is a flowchart illustrating a process by which a food item is rehydrated with a steamer in accordance with some embodiments.

FIG. 4 is an illustration of a steamer in accordance with some embodiments.

FIG. 5 is an illustration of a steamer with attachments in accordance with some embodiments.

FIG. 6 is an illustration of a food dispensing unit in accordance with some embodiments.

FIG. 7 is an illustration of a food item preparation process according to some embodiments.

FIG. 8 is an illustration of the steam output in accordance with some embodiments.

FIG. 9 is an illustration of the steam output and plate in accordance with some embodiments.

FIG. 10 is an illustration of a plate design in accordance with some embodiments.

FIG. 11 is an illustration of a plate seal in accordance with some embodiments.

FIG. 12 is a block diagram of a computing system in accordance with some embodiments.

The figures depict various embodiments of the present invention for purposes of illustration only. One skilled in the art will readily recognize from the following description that other alternative embodiments of the structures and methods illustrated herein may be employed without departing from the principles of the invention described herein.

### DETAILED DESCRIPTION

The following description and corresponding figures relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Overview

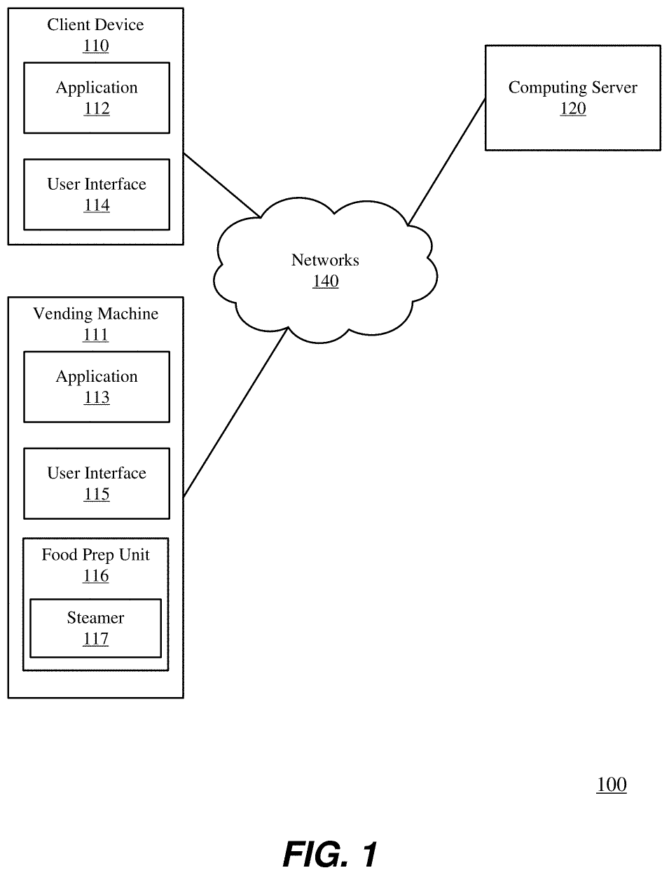

FIG. 1 is block diagram illustrating an example system environment, in accordance with some embodiments. In some embodiments, the system 100 may include one or more client devices, a computing server 120, and networks 140. A client device 110 may take the form of a computing device, such as a personal computer, a smartphone, a wearable device (e.g., smartwatch or fitness band), etc. In various embodiments, the system 100 includes fewer and additional components that are not shown in FIG. 1. The components in the system 100 may communicate through the network 140.

While some of the components in the system environment 100 may at times be described in a singular form while other components may be described in a plural form, the system environment 100 may include one or more of each of the components. For simplicity, multiple instances of a type of entity or component in the system environment 100 may be referred to in a singular form even though the system may include one or more such entities or components. For example, in some embodiments, while the client device 110 is sometimes described in a singular form, the computing server 120 may be a service provider that serves multiple client devices 110 simultaneously. Conversely, a component described in the plural form does not necessarily imply that more than one copy of the component is always needed in the environment 100.

A client device 110 may be controlled by a client of the server 120 who inputs various information such as actions, profiles, communities etc. The client device 110 may be referred to as a user device or an end user device. Each client device 110 may include one or more applications 112 and one or more user interfaces 114. The client devices 110 may be any computing devices. Examples of such client devices 110 include personal computers (PC), desktop computers, laptop computers, tablets (e.g., iPads), smartphones, wearable electronic devices such as smartwatches, or any other suitable electronic devices. The client device 110, server 120 and vending machine 111 may transmit information through the network 140.

The application 112 may be configured to allow users of the client device 110 hosting application 112 to order and customize food from the vending machine 111. The application 112 may include a menu displaying food options that can be prepared by a food preparation unit 116 of the vending machine 111. An application 112 may be in communication with the computing server 120 via the network 140. The application 112 may receive various inputs from the users comprising a choice of food items, sauces to put on the food items. The application may process user input into instructions for the controllers of the vending machine 111, but that processing may also occur at the vending machine 111.

In various embodiments and depending on the type of client device 110, the application 112 may take different forms. In one embodiment, the application 112 is a web application or a mobile application. In one embodiment, an application 112 is a web application that runs on JavaScript or other alternatives, such as TypeScript, etc. In the case of a web application, the application 112 may cooperate with a web browser, which is an example of user interface 114, to render the visual elements and interactive fields of the application 112. In another case, an application 112 is a mobile application. For example, the mobile application runs on Swift for iOS and other APPLE operating systems or on Java or another suitable language for ANDROID systems. In yet another case, an application 112 is a software program that operates on a desktop operating system such as LINUX, MICROSOFT WINDOWS, MAC OS, or CHROME OS.

Application 113 of the vending machine 111 may comprise all of the functional capabilities of application 112 of the client device 110. Applications 112/113 can receive user input of food item selections and more. Both applications 112/113 are updated by the server 120 such that they can display the same information. Application 112 of the client device 110 allows users of the client device 110 to order specified food items with sauce customizations from the vending machine 111 remotely and then pick up their meal at a later time. Application 113 allows a user of the vending machine 111 to order at the vending machine 111 using interface 115. The client device 110 communicates orders to the vending machine 111 while the vending machine 111 may also receive orders locally.

In one embodiment, the computing server 120 manages and provides the application 112/113. For example, the company operating the computing server 120 may be a cloud service provider that provides a front-end software application that can be installed, run, or displayed at a client device 110 or vending machine 111. For example, the company provides the applications 112/113 as a form of software as a service (SaaS). In one case, an example application 112/113 is published and made available by the company operating the computing server 120 at an application store (e.g., App store) of a mobile operating system.

The user interfaces 114 and 115 may be any suitable interfaces for receiving inputs from users and for communication with users. The user interfaces 114/115 may take different forms. In one embodiment, the user interface 114/115 is a web browser such as CHROME, FIREFOX, SAFARI, INTERNET EXPLORER, EDGE, etc. and the application 112 is a web application that is run by the web browser. In another application, the user interface 114/115 is part of the application 112/113. For example, the user interface 114/115 is the front-end component of a mobile application or a desktop application. The user interface 114/115 also may be referred to as a graphical user interface (GUI) which includes graphical elements to display various elements of the application 112/113. In another embodiment, the user interface 114/115 may not include graphical elements but communicates with the computing server 120 via other suitable ways such as application program interfaces (APIs).

User interfaces 114/115 may include visual displays of a menu of food items for selection as well as images of the food items on the menu. In one embodiment, a user may scroll through the menus to see different options. Once a user has chosen their food, they may choose the types of sauces from a sauce menu such as by checking boxes displayed in the interface 114/115. The user interface 114/115 may be similar or nearly the same on the client device 110 and the vending machine 111 with differing sizing and scaling across devices.

The food preparation unit 116 (also referred to as the food prep unit) prepares and dispenses food based on user input. The food prep unit 116 may be a part of the vending machine 111 or may be external to the vending machine 111 and communicate with it wireles sly through a network 140. The food prep unit may receive pre-processed information in the form of instructions from the application 113, the instructions describing actuation mechanisms for dispensing the food. The food preparation unit 116 may comprise compartments of pre-portioned food items separated by type (e.g., separate compartments for servings of rice, servings of chicken, etc.). In another embodiment the compartments may have bulk inventory of food items and be equipped with a portioning mechanism that is activated for each order. The food prep unit 116 has a mechanism for serving food items into a bowl or plate. In one embodiment the mechanisms comprise a motor that causes an arm to press on a flexible wall of a food compartment to push its contents out and into a bowl below.

The steamer 117 of the food prep unit 116 releases steam to hydrate or rehydrate food items. In one embodiment the steamer 117 may be enclosed in the vending machine 111 that receives user inputs and has a variety of units to prepare and dispense the ordered food items. In other embodiments, the steamer 117 or food prep unit 116 may be separate from the vending machine such as in separate units in a kitchen. The steamer 117 may additionally function to heat, thaw, or steam food items such as frozen foods or raw vegetables. The steamer 117 receives instructions from the application 112/113 indicating the time and pattern in which the steamer 117 should release steam. The application 112/113 may receive user input indicating a food item to be prepared by the food prep unit 116. The application 112/113 may convert the user input to instructions specifying the preparation for the chosen food item such as a temperature the food item should be heated to or a time the food item should be steamed for. The instructions taken by the steamer 117 may include steam time, final temperature, steam pressure, steam pattern or an indication of a flavor to add. The steamer 117 may additionally receive data stored in the computing server 120 describing the preparation of food items.

The computing server 120 is one or more computing devices that process inputs from users and generate various results. In this disclosure, the computing servers 120 may collectively and singularly be referred to as a computing server 120, even though the computing server 120 may include more than one computing device. For example, the computing server 120 is a pool of computing devices located at the same geographical location (e.g., a server room) or distributed geographically (e.g., cloud computing, distributed computing, or in a virtual server network). In some embodiments, the entity operating the computing server 120 may be the publisher of the application 112/113, which communicates with the computing server 120 to download various data generated by the computing server 120.

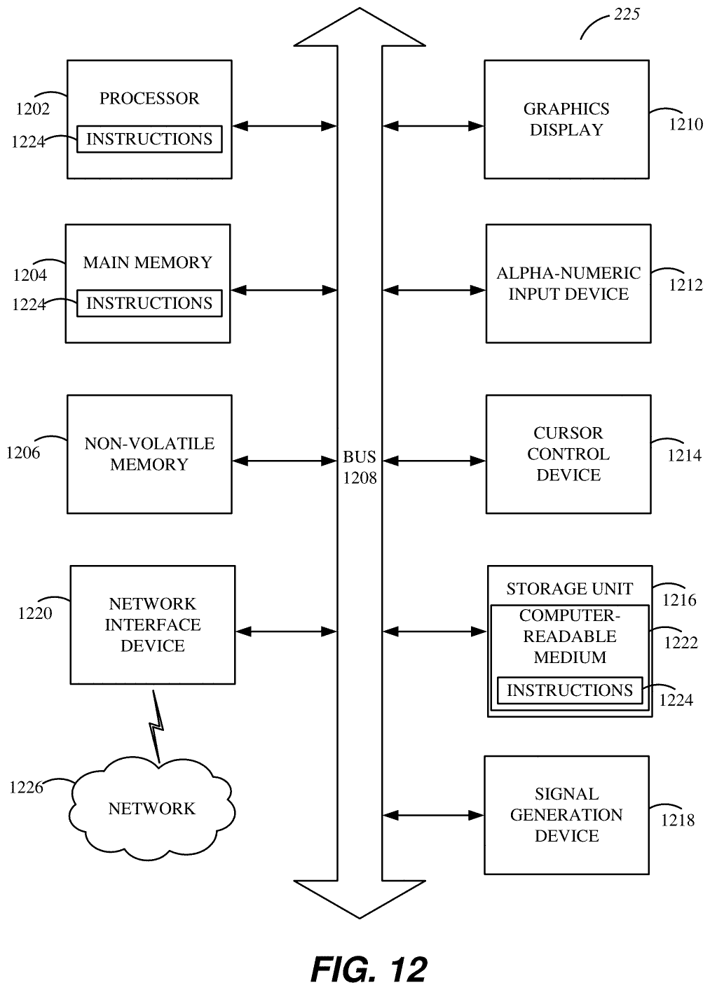

A computing device of the computing server 120 takes the form of software, hardware, or a combination thereof (e.g., a computing machine of FIG. 12). For example, parts of the computing server 120 may be a PC, a tablet PC, a smartphone, an internet of things (IoT) appliance, or any machine capable of executing instructions that specify actions to be taken by that machine. Parts of the server 120 may include one or more processing units (e.g., a central processing unit (CPU), a graphics processing unit (GPU), a digital signal processor (DSP), a controller, a state machine, one or more ASICs, one or more RFICs, or any combination of these) and a memory.

The communications between the client devices 110/111 and the server 120 may be transmitted via a network 140, for example, via the Internet. The network 140 may provide connections to the components of the system through one or more sub-networks, which may include any combination of local area and/or wide area networks, using both wired and/or wireless communication systems. In one embodiment, a network 140 uses standard communications technologies and/or protocols. For example, a network 140 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 140 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 140 may be represented using any suitable format, such as hypertext markup language (HTML), extensible markup language (XML), or JSON. In some embodiments, all or some of the communication links of a network 140 may be encrypted using any suitable technique or techniques such as secure sockets layer (SSL), transport layer security (TLS), virtual private networks (VPNs), Internet Protocol security (IPsec), etc. The network 140 may also include links and packet switching networks such as the Internet.

The server 120 may access a database storing food item options, menus, and instructions for preparing food items. Content in the server 120 database may be updated remotely by an administrator of the system. The server 120 may then communicate its new contents via the network 140 enabling automatic updating of all client devices 110 and vending machines 111 remotely.

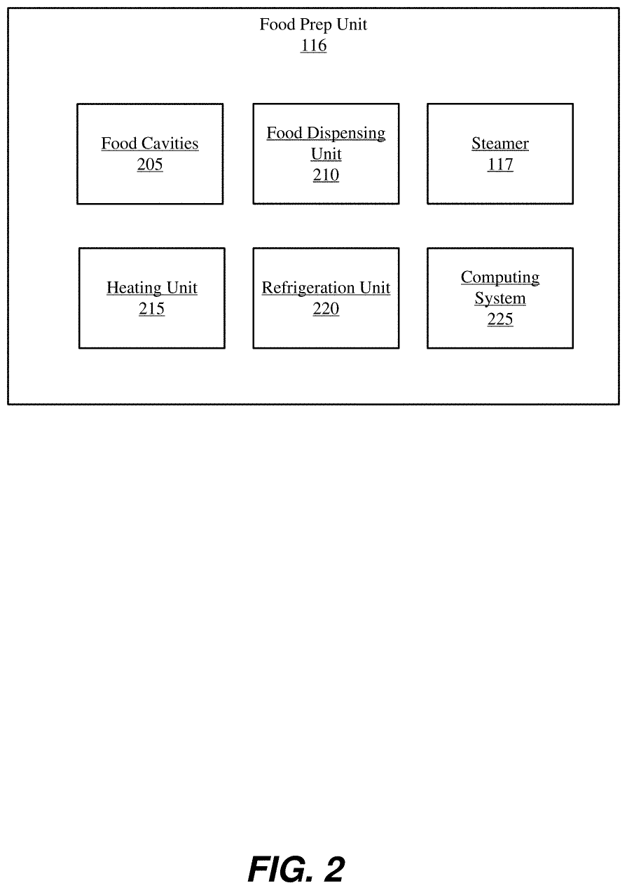

FIG. 2 is a block diagram illustrating the system architecture of a food preparation unit in accordance with some embodiments. The food prep unit 116 comprises food cavities 205, a food dispensing unit 210, a steamer 117, a refrigeration unit 220, and a computing system 225. In some embodiments the components of the food prep unit 116 are housed within the vending machine 111. Other embodiments may have more or fewer components of the food prep unit 116.

The food cavities 205 are compartments of flexible material such as silicone for holding food. The food cavities 205 may hold a pre-portioned amount of food for one order in each or a bulk amount of food that is dispensed over several orders. The food cavities 205 are supported by a grid of cubbies such that each cavity is supported and attached to a rigid frame. The food cavities 205 and grid are further described below.

The food dispensing unit 210 comprises a motorized arm that travels along the frame or grid supporting the food cavities 205 and dispenses a portion of food. The food dispensing unit receives instructions from a controller of the vending machine 111 or food prep unit 116 to dispense food items into a bowl as indicated by user input. The food dispensing unit 210 may dispense a portion of food out of the food cavities by operating a motorized punch that pushes on a flexible wall of the food cavity 205, pushing the food item out of an opening on the opposite side of the cavity. The punch navigates to the correct food cavity in the grid with instructions from user input.

The steamer 117 outputs hot vapor to rehydrate and heat food. The vapor (e.g., steam) output by the steamer 117 may be water or another heated liquid with added flavor such as broth or water with dissolved spices. An output (or outlet) line may provide a pathway for steam or pressurized water to be directed to a location such as a container. For example, pressurized atomized water may be applied that need not be heated as a heating process may subsequently be applied, e.g., via an oven, if needed. The output line also may be referred to as a conduit (or enclosed conduit). The flavor of the vapor may be chosen when the user inputs their order to the application 112/113 of their client device or the vending machine 111. The user may, for example, choose a level of spice or a flavor preferred they determines the amount of flavored vapor dispensed by the steamer 117. The steamer may output vapor at varying temperatures, pressures, or patterns dependent on the food item being prepared. The steamer 117 may receive a food item container via a conveyor belt or other means of aligning a container under the steamer output. Food items may first be dispensed into the container by food dispensing unit 210 after which the container may travel to the heating unit 215 or steamer 117 for preparation of the food items. Herein the container is referred to as a bowl. However, the container may take on the suitable form factors other than a bowl such as a plate, tray, or cup.

The heating unit 215 heats areas of the food prep unit 116. The heating unit 215 heat specific food cavities 205 that hold pre-cooked food to be served hot. The heating unit 215 may be comprised of heated plates or heating lamps to provide localized heating. The heating unit 215 may also comprise a heated cabinet that encloses portions of the food prep unit 116.

The refrigeration unit 220 provides temperature control to temperature sensitive elements of the food prep unit 116. The refrigeration unit 220, in some embodiments, is a refrigerated cabinet that encloses the entire vending machine 111 or the food prep unit 116. In these embodiments, any area of the vending machine 111 or food prep unit 116 for warm or hot food items is insulated to isolate the heated area from refrigeration. In other embodiments, the refrigeration unit 220 may provide localized temperature control such as by running refrigerant through tubes to areas that require cooling. The refrigeration unit 220 may comprise several separate units if the components of the food prep unit are house separately.

The computing system 225 may receive information from the application 112/113 based on user input to the client device 110 or vending machine 111. The computing system 225 processes the user input to the applications 112/113 such that it is readable by the components of the food prep unit 116. The computing system 225 is further described below.

In some embodiments, the food prep unit 116 has additional components such as a lidding unit and order delivery unit. The lidding unit applies a lid or seal to a prepared order once it is complete. The order delivery unit distributes orders into specific lockers that can only be opened by the user who made the order.

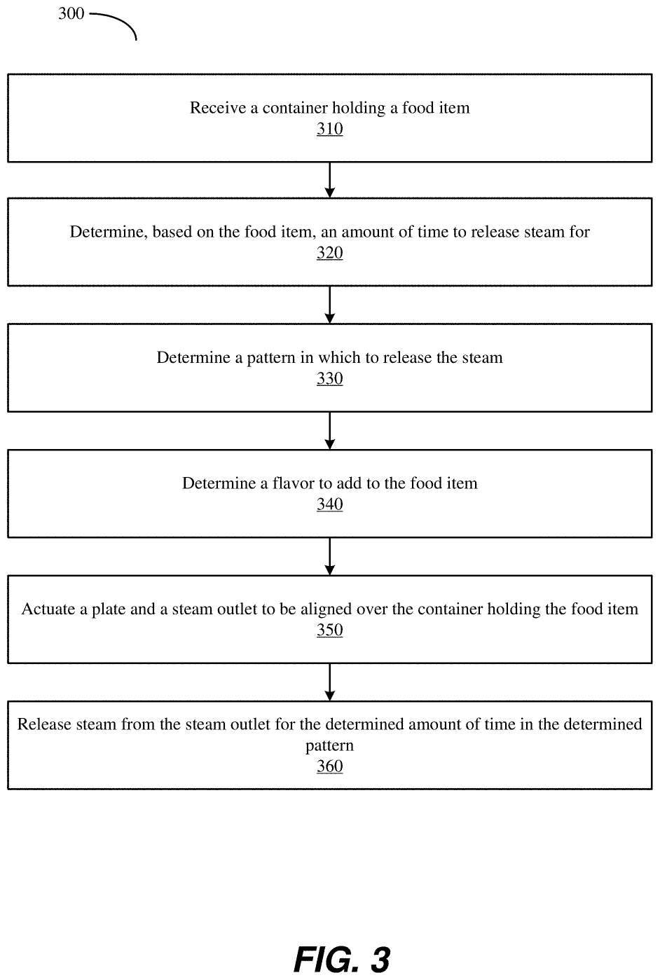

FIG. 3 is a flowchart illustrating a process 300 by which a food item is rehydrated with a steamer in accordance with some embodiments. In some embodiments, the steps of process 300 may occur in different orders or with fewer or additional steps.

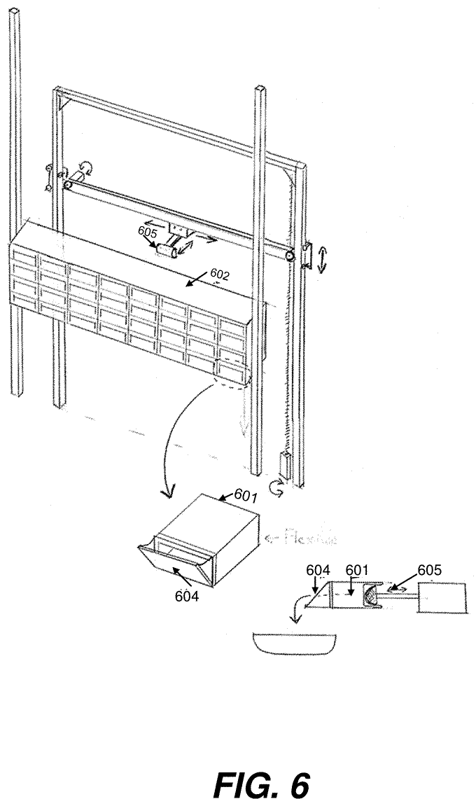

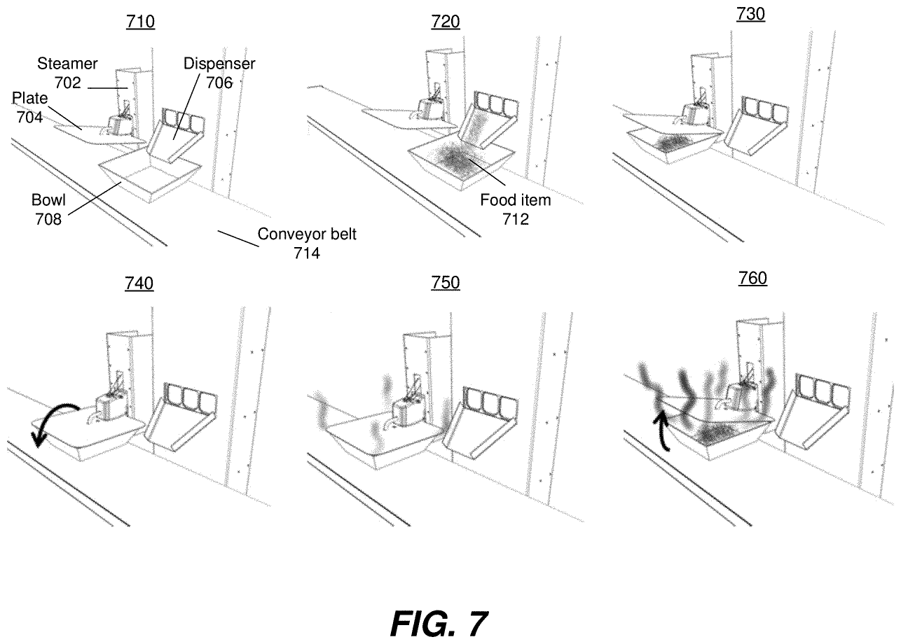

The steamer 117 of the food preparation unit receives 310 a container holding a food item. The container may be transported to the steamer 117 via means such as a conveyor belt. The steamer 117 may have alignment beams such that when the container passes under the steamer and breaks a light beam (e.g., a laser) a sensor is triggered indicating that the container is aligned under the steam output. Other means of alignment sensing such as capacitance or weight sensors may be used to detect the position of the container under the steam output. The container holding the food item, in some embodiments, is the container that the food is served in which prevents waste and the need for cleaning mixing bowls. The container may travel to the steamer 117 from other units of the food preparation unit 116 such as a heating unit or a dispensing unit. Other units of the food prep unit 116 are described with reference to FIGS. 6 and 7.

The food preparation unit 116 determines 320, based on the food item, an amount of time to release steam from the steamer 117. In some embodiments the amount of time may be determined by the application 112/113 or computing server 120 and communicated to the steamer 117 via a network (e.g., the network 140). The amount of time to release steam may also be associated with an amount of time to hold the steam in the container after the steam has been dispensed. For example, the application 112 may, based on user input, communicate to the steamer to release steam for 1 minute and then continue to hold the steam in the container for an additional 1 minute before letting the steam escape from the container. In some embodiments the amount of time for steaming may be replaced with a goal temperature for the container or food item such that the steamer stops releasing steam once the goal temperature is reached.

The food preparation unit 116 also determines 330 a pattern in which the steamer 117 releases steam. In some embodiments the pattern may be determined by the application 112/113 or computing server 120 and communicated to the steamer 117 via a network (e.g., the network 140). The pattern, based on the chosen food item, may be determined to agitate the food item such that it is rehydrated or heated evenly. For example, if the food item is a bowl of rice, a pattern of strong bursts of steam may move the grains and separate them so that the rice is rehydrated evenly, rather than only the top layer of the rice being rehydrated by a constant stream of steam. The pattern may consist of bursts of high pressure steam with stops in between at a chosen frequency. The pressure and frequency of the bursts of steam may be customizable based on the food item. The pattern may be expressed to the steamer as a pulse-width modulation function having a variable duty cycle at which the steam is turned on and off. Other control functions may also be used.

In some embodiments the food preparation unit 116 determines 340 a flavor to add to the food item during steaming. flavor may be added to the food item by steaming the food item with a flavor liquid rather than water. Flavor may also be added by passing the steaming liquid through a cartridge containing spices of the desired flavor such that the liquid is imparted with the flavor of the spices before it is output by the steamer. For example, a user of the vending machine 111 may order a spicy chicken and rice bowl and select a level of spice. The food dispensing unit will dispense chicken and rice into a container and the container will be moved to the steamer 117. The steamer 117 will receive instructions for which spice and how much of the spice to add based on the user's spice level selection. The steamer may then pass the steam through a cartridge of the desired spice, such as cayenne, and then dispense the spiced steam onto the chicken and rice in the container. In other embodiments the steamer may release an amount of powered spice near the steam output such that it mixes with the steam as the steam is expelled from the output.

The steamer 117 then actuates 350 a plate to be aligned over the container holding the food item. The plate may be a food grade material, e.g., a food grade tempered glass, plastic, silicon, rubber, ceramic, or metal. The plate covers the opening of the container and has a hole through which the steam outlet dispenses steam. The steamer 117 receives instructions such as from the food prep unit 116or application to actuate the plate into steaming position. The actuator is powered on responsive to the instructions and moves the plate. The actuator may pivot the plate onto the container, lower the plate from above the container, slide the plate from beside the container or perform other actuations of the plate. The direction of actuation may vary with the embodiment of the steamer. The container may be deformable such that when the actuator applies force to the container via the plate, the container deforms to seal steam in. In some embodiments the plate may not need to be actuated and instead the container may move under the plate with a small clearance between the plate and the container such the majority of the steam is sealed into the container.

Once the plate has been actuated onto the container, the steamer 117 releases 360 steam from the steam outlet for the determined amount of time in the determined pattern. The steam may be released via a pump connected to a reservoir of heated water or flavored liquid, such as broth. The steam may alternatively pass through a cartridge of spices, imparting flavor to the steam before it is released into the container. The structure also may be configured to provide a spray of fine atomized water/flavor liquid rather than steam to thereafter heat so that the mixed in moisture provides the steam when heated. The steamer 117 may be equipped with a temperature sensor on the plate to sense the temperature of the food item to check for doneness if an amount of time or pattern is not specified.

### Exemplary Steamer Embodiment

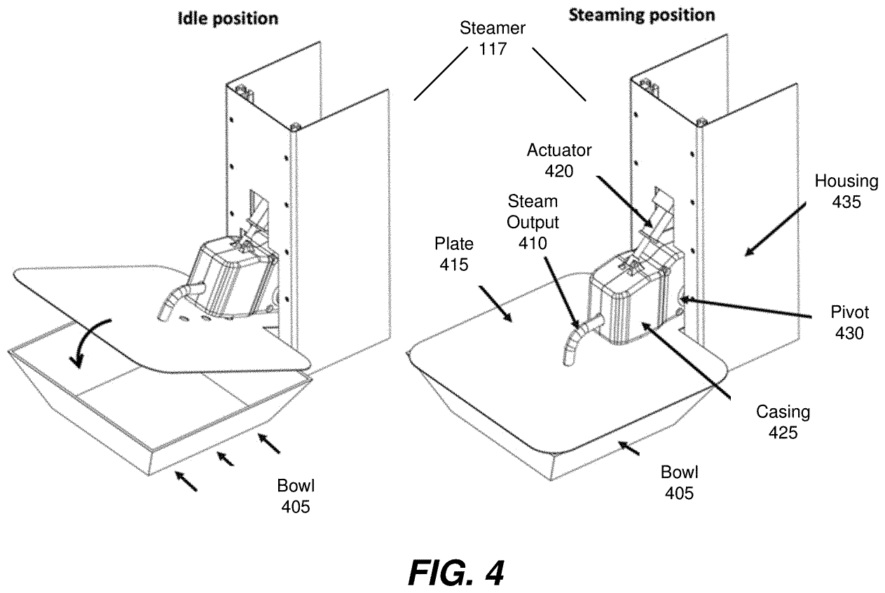

FIG. 4 is an illustration of a steamer (e.g., steamer 117) in accordance with some embodiments. The steamer 117 receives a bowl 405 that is aligned under a plate 415. The bowl 405 may be made of deformable, food-safe material such as paper, cardboard, or polystyrene. The plate 415 may be made of a food grade material, e.g., a food grade tempered glass, plastic, silicon, rubber, ceramic, or metal, and is a heat resistant material. In some embodiments the plate may have a flange or seal around the edge to between seal the connection point between the bowl 405 and the plate 415 while steaming. A steam output (or outlet) 410 may be a pipe (or tube or other enclosed conduit) through which steam is pumped out of the opening of the pipe and into the bowl 405. The steam output 410 is removably coupled to a hole in the plate 405. The steam output 410 may be a steam outlet pipe (or other enclosed conduit) having a first end coupled with an opening of the casing 425 and a second end opposite to the first end coupled with a opening on the plate 415. The first end coupled to the opening of the casing 425 may further be coupled through the casing 425 to a moisture source within the housing 435. In alternate embodiments, the moisture source 435 may be distal from the housing and the conduit in that instance would have one end directed to that moisture source. The moisture source may be a steam source may be vessel (or other container), e.g., glass or food grade plastic, ceramic, silicon, or metal, to hold a liquid, e.g., water. The vessel may be further structured to allow heating of the liquid to a temperature to generate steam that may be directed through the conduit, e.g., pipe, into the bowl 405. In other embodiments, the moisture source may be a pressurized liquid source. The pressurized liquid source may be a cartridge or other vessel that holds a liquid, e.g., water or flavor, under pressure and releases it through the conduit, e.g., 410, into the bowl 405. Once the moisture is within the bowl 405 and/or mixed with the bowl 405 contents, the bowl 405 may be transported to a heating chamber, e.g., an oven, where the applied heat in that chamber allows the contents of the bowl 405 to heat. The applied heat may be applied at a predetermined temperature, e.g., set an oven to 350 degrees Fahrenheit.

The plate 415 is removably coupled to the actuator 420 via attachment such as a clip or screw. The plate 415 has a top and a bottom. The bottom faces towards the bowl 405. In some embodiments, a perimeter portion of the bottom of the plate may include a seal, e.g., a rubber gasket, that is a same perimeter as a perimeter of the bowl to provide a seal with the bowl 405. The seal may include one or more openings to allow some steam to escape or may include a tight seals to enable steam to stay within the bowl 405. The plate 415 may be removed from the actuator 420 and decoupled from the steam output 410 for washing or replacement. In some embodiments the plate 415 may be fixed, removing the need for an actuator 420. In such embodiment, the bowl 405 may move along a conveyor and align just under the bottom of the plate 415. A gap between a lip of the bowl and the bottom of the plate may be sufficiently small so that the bulk of the steam remains directed within the bowl 405. In other embodiments, the bowl 405 move from a conveyer onto a floor plate directly under the bottom of the plate 415. The floor plate may lift the bowl 405 up and towards the bottom of the plate 415. After steam is applied, another actuator may move the bowl 405 out from under the bottom of the plate 415 onward to the next destination.

The actuator 420 comprises a motor or hydraulic arm configured to move the steam output 410 and plate 415 into contact with the bowl 405. The actuator 420 may pivot or otherwise translate the plate from idle position to steaming position. The actuator 420 is protected by a casing 425 that prevents food items or liquids from touching the actuator 420 components. The casing 425 and plate 415 may be anchored to a pivot 430 around which the components rotate as the actuator moves the plate 415. Further components of the steamer 117, such as a liquid reservoir and pump, may be protected by a housing 435. The housing 435 may be structured to mount the actuator 420 and the pivot.

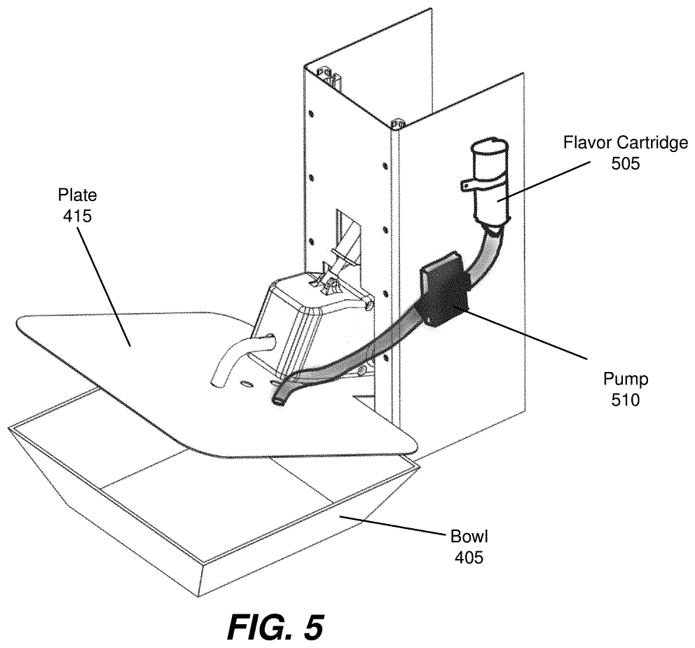

FIG. 5 is an illustration of a steamer (e.g., steamer 117) with attachments in accordance with some embodiments. The attachments in the shown embodiment of FIG. 5 comprise a flavor cartridge 505 and pump 510. The flavor cartridge 505 may be internal or external to the housing 435 and contains spices or other flavorings that can be mixed with liquid and released into the bowl 405. A conduit (or pipe or tube) has a first end a second end. One end couples with a second opening between the top surface and bottom surface of the plate 415 and the other end couples with the flavor cartridge 505 via the pump 510. The pump 510 may be a peristaltic pump that moves flavored liquid from the flavor cartridge 505 through tubing to the bowl 405 where it is dispersed as steam or small droplets of liquid. In some embodiments the flavor cartridge 505 may be located near the steam outlet such that the steam can travel through the flavor cartridge and pick up flavor before it is dispersed into the bowl 405. It is noted that the flavor cartridge may be also be vessel that contains the flavoring liquid or substance.

FIG. 6 is an illustration of a food dispensing unit of a food preparation unit in accordance with some embodiments. The food dispensing unit of FIG. 6 and description below is an exemplary way of dispensing food. However, other methods may be used.

Rather than portioning by hand through the use of a measuring scoop or filling each flexible cavity 601 (e.g., food cavities 205) individually the operator simply has to ensure all cavities are filled to the top. Through use of the portion control positive the operator does not need to change steps for different volumes.

One object of embodiments is to enable accurate pre-portioning and dispensing of food for the purpose of automating the creation of made-to-order dishes. To accomplish this a matrix of thin highly flexible cavities 601 which can vary in material, stiffness, thickness, shape etc. for desired storage conditions, actuation, and content ejection behavior is described. Potential materials for this matrix include silicone, rubber, aluminum, and plastics. These pockets can be put into a matrix of arbitrary size and they can also have heating or cooling units, insulation, and sensor packages embedded into their material. The flexible cavities can be of various dimensions to best suit the need of the material being dispensed and the end use case.

In one example the flexible cavities 601 are a rectangular shape with a depth of 7 inches and a width and height of 2 inches for a total volume of 28 in³. In another example for the dispensing of a different volume of ingredient the depth is shortened to 4 inches and instead of a rectangular opening a circular cavity with a radius of 2 inches is used for a total volume of 50.25 in³. These flexible cavities can be used in the dispensing of ingredient across a wide range of use cases and in a variety of useful physical setups. The size and volume vary in different embodiments.

In one embodiment the matrix of flexible cavities 601 is placed inside of a grid 602 for easy transportation and use. This grid can be made of a flexible or rigid material as well. With a watertight and/or airtight lid 604 and series of nozzles the entire unit can be turned to any desired dispensing angle/orientation with no spilling or leakage. The figures in this application show vertical/horizontal orientations but any orientation could be used. The lid can be held/screwed in place with snap features, screw fasteners, magnets etc.

The grid 602 can be used to keep ingredients hot or cold while in storage. This grid could be an active subsystem with one or both of a heating or cooling system and/or a passive insulated system. In one embodiment, the combination of the flexible cavity 601, grid 602, lid 604, and nozzle is called a food dispensing unit 210 and is shown in FIG. 2. Potential examples of end use cases for this dispenser unit include use in the back of house of a restaurant, customer facing in a dining hall or buffet setting, and in an automated vending capacity which is the use case discussed at length herein.

In an embodiment of a vending machine 111 use case, a customer orders a dish that requires multiple ingredients from one or more of the dispensing units held inside the machine 111. The machine 111 is loaded with one or more dispenser units and dispenses materials from the matrix of flexible cavities 601 within those dispenser units to create the dish for the customer by filling or partially filling a delivery unit.

In one embodiment each matrix within a dispensing unit can include a single type of ingredient and multiple matrices can be used with multiple dispensing units to provide access to dishes that have multiple ingredients. In another embodiment, a single flexible matrix can include multiple ingredients and can be used with one or more dispensing units.

This delivery unit is moved such that it can receive the ingredients dispensed from the correct flexible cavity 601. This flexible cavity is then compressed via a punch 605 such that the ingredient material exits the cavity through a nozzle with the desired velocity and final shape in the target delivery unit. This punch can be used to dispense any amount of the content of the target flexible cavity from 0 to 100%. The punch itself may have heating or cooling options and/or will have dimensional tolerances such that the punch ensures correct portion of cell is emptied upon command. This enables vending of precise amounts of food alone or as part of a larger system or machine 111 via the punch. This punch could be screw driven, spring driven, pneumatic, hydraulic, powered by overactive hamsters, etc.

Retraction of the punch 605 from a given flexible cavity drives retraction of the flexible cavity 601 itself through variety of potential means including but not limited to latching features, magnets, hook and loop, and/or permanent or temporary adhesives.

The nozzles by design prevent all or substantially all dripping or clinging for the given material held in the matrix of flexible cavities 601. The nozzle design can completely change for given materials and can have additional features such as sieves, filters, blades, etc. to aid in dispensing, cleaning, or other purposes. Particular nozzle shapes may be chosen for the desired final presentation of the ingredients within the delivery unit or for the optimal setup for future steps. The nozzles could be active or passive elements and/or contain active elements and/or sensors in their internal structure. For example, embedded sensors could be used to detect the water content of the passing ingredients, their temperature and the ambient temperature and pressure of the machine internals, etc.

When necessary the vending machine 111 can move a given dispenser unit so the next row of flexible cavities 601 is closest to the delivery unit, when a previous row of flexible cavities is empty, the movement of the dispenser unit can occur through a variety of techniques, e.g., using hydraulics, lead screw, cam, etc. This enables the clean dispensing of many different ingredients into the delivery unit and for compact storage of ingredients. After the desired ingredients are selected and dispensed the delivery unit is moved to the next step of the dish making process which may include mixing, shaking, reheating, sealing, steaming, braising, broiling, the addition of more ingredients, etc.

Herein describes some of the operations/methods for filling the flexible cavities 601 as these new methods represent significant cost and labor savings over other methods of pre-portioning ingredients. When used with a portion control positive, and scraper/pusher filling becomes efficient through a pouring/scraping/shaking action. The portion control positive forces the flexible cavity to compress (much like the punch 605 does during dispensing) to a desired volume. The ingredient is then poured out of a vessel over the open face of the flexible cavity and the flexible cavity is filled. Excess is scraped over the remaining flexible cavities using a scraper/pusher and the process is repeated until the entire matrix of flexible cavities is filled. This can be driven by hand or by machine and is a scalable process that can be grown to accommodate an arbitrary number of dispenser units. A vibration assistant can also be used to aid with ingredient settling.

FIG. 7 is an illustration of a food item preparation process according to some embodiments. The components involved in the process of FIG. 7 are a steamer 702 (e.g., steamer 117), a plate 704 (e.g., plate 415), a dispenser 706 (e.g., the food dispensing unit 210), a bowl 708 (e.g., bowl 405), a food item 712, and a conveyor belt 714. In other embodiments additional components may be involved and different steps may occur.

At step 710 the bowl 708 is positioned on the conveyor belt 714 under the dispenser 706. The bowl 708 may be aligned under the dispenser 706 using sensors to detect the position of the bowl 708 along the conveyor belt 714.

At step 720 the dispenser 706 releases a food item 712 into the bowl 708. In the shown embodiment the food item 712 may be a food having several granules such as rice or other grains. The dispenser 706 may dispense a specific portion amount of the food item 712 based on size or weight of the food item. The dispenser 706 may also have cavities (e.g., flexible cavities 205) filled with pre-portioned amounts of a food item for each order. The punch 605 mechanism of FIG. 6 may be used to push the food item out of the cavity and onto a dispensing slide as seen in step 720.

At step 730 the conveyor belt 714 moves to align the bowl 708 under the steamer 702. Again, sensors may be used to determine the position of the bowl 708 relative to the steamer 702 or the conveyor belt 714 may move a predetermined amount that matches the distance between the dispenser 708 and the steamer 702. The plate 704 of the steamer 702 is in the idle position meaning that the plate 704 is actuated up such that it does not come into contact with the bowl 708 as the bowl 708 is aligned under the steamer 702.

At step 740 the plate 704 is actuated to the steaming position. The actuation in this embodiment is a rotation around a pivot that lowers the plate 704 onto the bowl 708.

At step 750 the steamer 702 is active and dispenses steam into the interior of the bowl 708 to rehydrate the food item 712. The steam is released from the steamer 702 in a pattern and for an amount of time that is dependents on the food item 712. Steam is shown exiting the bowl 708 to demonstrate the activity of the steamer 702. However, in some embodiments the plate 704 is sealed to the bowl 708 such that no steam escapes. In other embodiments the plate 704 may not precisely seal to the bowl 708 or the plate may be vented to prevent pressure from building up. The pattern of steam tosses or mixes the food item 712 granules such that the food item is hydrated evenly. The steam may stop at step 750 while the plate 704 is in steaming position, and the steam may be held in the bowl 708 for a period of time.

At step 760 the steamer 702 stops releasing steam plate 704 is raised back to the idle position. depending on the embodiment the bowl 708 may move down the conveyor belt 714 to another unit for further heating (e.g., at the heating unit 215) or addition of sauces before being dispensed to the user.

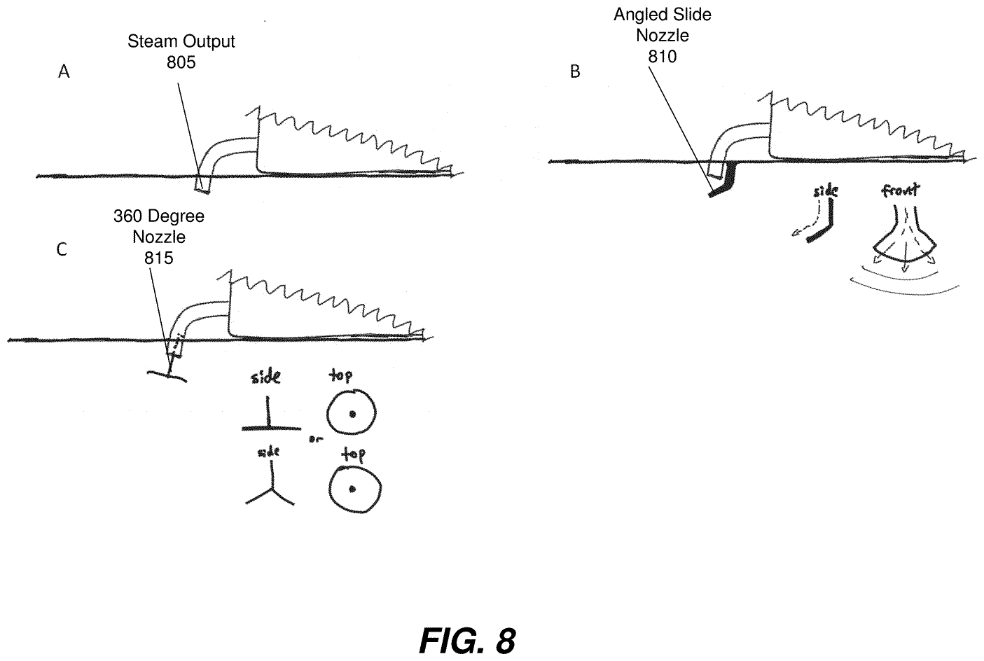

FIG. 8 is an illustration of the steam output 805 (e.g., an embodiment of steam output 410) in accordance with some embodiments. The steam output 805 may simply be an open-ended pipe in some embodiments. The simple pipe configuration outputs a linear jet of steam and does not diffuse the steam in any specific direction. In some embodiments it may be preferable to diffuse the steam or direct it in a certain angle for even hydration and heating of a food item. Angled slide nozzle 810 is an embodiment of steam output 805 with an angled attachment that pushes the steam in the direction of the angled slide 810. The angled slide nozzle 810 may, for example, be removably attached to the steam output 805 such as by threading or permanently attached to the plate such as by welding. The angled slide nozzle 810 may have a fanned out portion to spread the steam across a plane at a desired angle determined by the angle of the slide. The 360 degree nozzle 815 similar functions to spread the flow of steam throughout the container holding the food item (e.g., bowl 405). The 360 degree nozzle 850 may be removably coupled to the steam output 805 or permanently installed within the steam output 805. The nozzle 815 may have a skirt portion that is perpendicular to the flow of steam out of the steam output. The skirt portion redirects the flow of steam in the direction of the skirt. The skirt may also be configured at different angles to direct the steam in alternate directions. In some embodiments the nozzles 810 and 815 may be interchangeable or actuatable based on the food item being steamed.

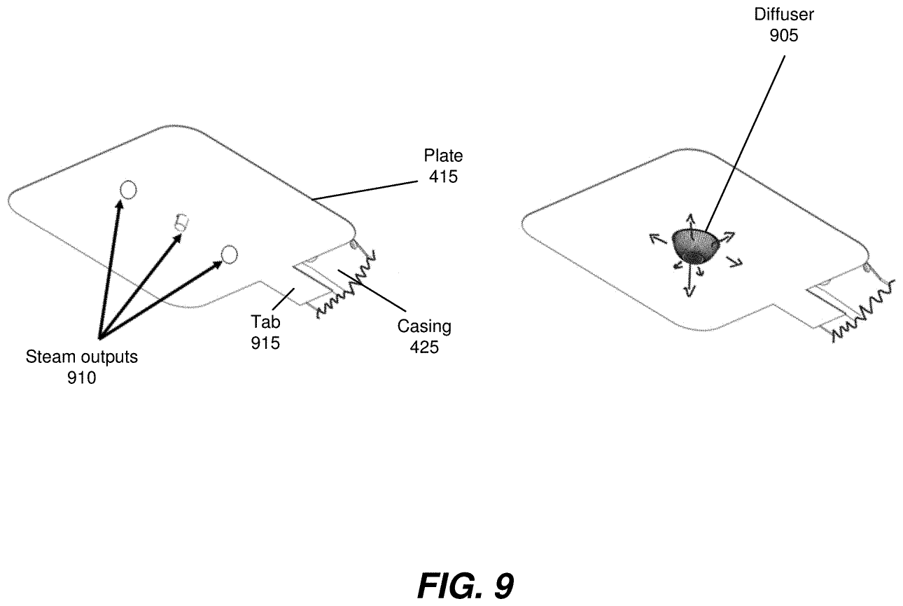

FIG. 9 is an illustration of the steam output (e.g., steam output 410) and plate (e.g., plate 415) in accordance with some embodiments. One or more steam outputs 910 can be located at different positions on the plate 415 according to the embodiment. The position of the steam output 910 may allow for more even heating and hydration of food items. In some embodiments the plate 415 may have multiple perforations through which the steam output 910 can be placed. There may also be multiple steam outputs 910 on a single plate to heat food items with two steam sources. The steam dispersion can further be controller by the addition of a diffuser 905 attachment that re-directs steam in many directions out of small holes in the diffuser 905. The diffuser 905 may additionally function to lower the pressure of the output steam before it reaches the food item.

In the shown embodiment, the plate 415 is of a roughly square shape with a tab 915 protruding from one side. The tab 915 may removably attach to the actuator casing 425 such that as the actuator (e.g., actuator 420) moves the plate moves with it.

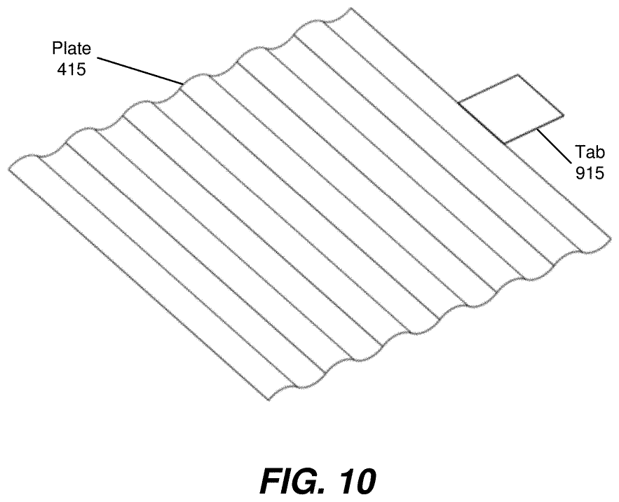

FIG. 10 is an illustration of a plate design in accordance with some embodiments. The plate 415 may be configured to have a specific shape or texture the encourage circulation of steam. In the shown embodiment the plate 415 has a pattern of waves which may encourage steam turbulence and agitate the food item for even steaming. The tab 915 remains flat to be coupled to the actuator casing. Other patterns, forms, or textures are possible and may depend on the use of the steamer. For example, the plate 415 may be textured with concentric rings emanating from the steam output to encourage the formation of steam vortices. The texture of the plate 415 may only be on a portion of the plate 415 that does not contact the sides of the bowl (e.g., bowl 405). The outer regions of the plate 415 may be flat while the inner region is textured, this may allow for the plate to form a more complete seal with the bowl.

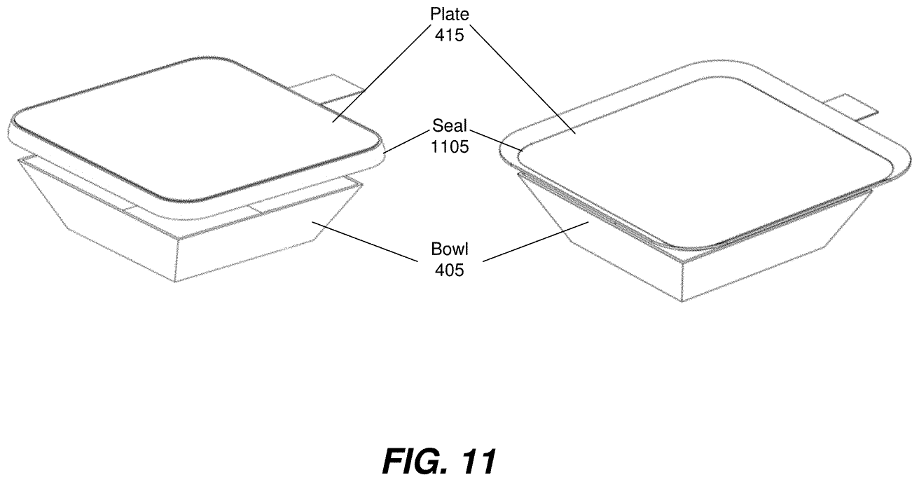

FIG. 11 is an illustration of a plate seal in accordance with some embodiments. The plate 415 may have a seal 1105 attached. The seal 1105 creates an air-tight fit between the plate 415 and the bowl 405. The seal 1105 may be of flexible material like silicone that conforms to the specific shape of the bowl 405 to form an air-tight fit. The seal 1105 may also be made of rigid material and overhang the edge of the bowl 405 to hold steam in. In some embodiments, the rigid seal 1105 can flip upwards or downwards to fit larger or smaller bowl 405 sizes.

### Example Computing Machine

FIG. 12 is a block diagram illustrating an example architecture of a computing device, in accordance with some embodiments. The computing device (or computer) is capable of reading instructions from a computer-readable medium and executing them in a processor (or controller). A computer described herein may include a single computing machine shown in FIG. 12, a virtual machine, a distributed computing system that includes multiples nodes of computing machines shown in FIG. 12, or any other suitable arrangement of computing devices.

By way of example, FIG. 12 shows a diagrammatic representation of a computing machine in the example form of a computer system 225 within which instructions 1224 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 12 may correspond to any software, hardware, or combined components shown in FIG. 1, including but not limited to, the user device 111, the computing server 120, and various engines, modules, interfaces, terminals, computing nodes and machines. While FIG. 12 shows various hardware and software elements, each of the components described in FIG. 1 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 1224 that specify actions to be taken by that machine. Further, while only a single machine is illustrated, the term “machine” and “computer” may also be taken to include any collection of machines that individually or jointly execute instructions 1224 to perform any one or more of the methodologies discussed herein.

The example computer system 225 includes one or more processors 1202 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 225 may also include a memory 1204 that store computer code including instructions 1224 that may cause the processors 1202 to perform certain actions when the instructions are executed, directly or indirectly by the processors 1202. Instructions can be any directions, commands, or orders that may be stored in different forms, such as equipment-readable instructions, programming instructions including source code, and other communication signals and orders. Instructions may be used in a general sense and are not limited to machine-readable codes. The processors 1202 may include one or more multiply-accumulate units (MAC units) that are used to perform computations of one or more processes described herein.

One and more methods described herein improve the operation speed of the processors 1202 and reduces the space required for the memory 1204. For example, the various processes described herein reduce the complexity of the computation of the processors 1202 by applying one or more novel techniques that simplify the steps in analyzing data and generating results of the processors 1202. The algorithms described herein also reduces the size of the models and datasets to reduce the storage space requirement for memory 1204.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 225 may include a main memory 1204, and a static memory 1206, which are configured to communicate with each other via a bus 1208. The computer system 225 may further include a graphics display unit 1210 (e.g., a plasma display panel (PDP), a liquid crystal display (LCD), a projector, or a cathode ray tube (CRT)). The graphics display unit 1210, controlled by the processors 1202, displays a graphical user interface (GUI) to display one or more results and data generated by the processes described herein. The computer system 225 may also include alphanumeric input device 1212 (e.g., a keyboard), a cursor control device 1214 (e.g., a mouse, a trackball, a joystick, a motion sensor, or other pointing instrument), a storage unit 1216 (a hard drive, a solid state drive, a hybrid drive, a memory disk, etc.), a signal generation device 1218 (e.g., a speaker), and a network interface device 1220, which also are configured to communicate via the bus 1208.

The storage unit 1216 includes a computer-readable medium 1222 on which is stored instructions 1224 embodying any one or more of the methodologies or functions described herein. The instructions 1224 may also reside, completely or at least partially, within the main memory 1204 or within the processor 1202 (e.g., within a processor's cache memory) during execution thereof by the computer system 225, the main memory 1204 and the processor 1202 also constituting computer-readable media. The instructions 1224 may be transmitted or received over a network 1226 via the network interface device 1220.

While computer-readable medium 1222 is shown in an example embodiment to be a single medium, the term “computer-readable medium” should be taken to include a single medium or multiple media (e.g., a centralized or distributed database, or associated caches and servers) able to store instructions (e.g., instructions 1224). The computer-readable medium may include any medium that is capable of storing instructions (e.g., instructions 1224) for execution by the processors (e.g., processors 1202) and that causes the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

In various embodiments, a non-transitory computer readable medium that is configured to store instructions may be used. The instructions, when executed by one or more processors, cause the one or more processors to perform steps described in the above computer-implemented processes or described in any embodiments of this disclosure. In various embodiments, a system may include one or more processors and a storage medium that is configured to store instructions. The instructions, when executed by one or more processors, cause the one or more processors to perform steps described in the above computer-implemented processes or described in any embodiments of this disclosure.

### Additional Considerations

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of embodiments. This description should be read to include one or at least one and the singular also includes the plural unless it is obvious that it is meant otherwise. The use of the term and/or is intended to mean any of: “both”, “and”, or “or.”

In addition, the language used in the specification has been principally selected for readability and instructional purposes and may not have been selected to delineate or circumscribe the inventive subject matter. Accordingly, the disclosure of the embodiments is intended to be illustrative, but not limiting, of the scope of the embodiments.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments.

What is claimed is:

1. A system for rehydrating a food item with steam, the system comprising:
a housing;
a steam source having an outlet, the steam source comprising an enclosed vessel within which a liquid is heated to generate steam for release through the outlet;
a plate having a top surface, a bottom surface and an opening traversing between the top surface and the bottom surface;
a casing coupled with the top surface of the plate and having a pivot point;
a conduit having a first end and a second end, the first end coupled with the opening at the top surface of the plate and the second end coupled with the outlet of the steam source; and
an actuator coupled with the casing on a first end and the housing at a second end, the actuator configured to move the casing from a first position to a second position by rotation about the pivot point, the first position to flow stream from the steam source towards the plate the second position to idle flow of steam from the steam source.

2. The system of claim 1, wherein the steam source is a container holding water.

3. The system of claim 2, wherein the plate is a food grade metal.

4. The system of claim 1, wherein the bottom surface includes a seal proximate around a perimeter of the plate.

5. The system of claim 1, further comprising a flavor vessel, and a flavor vessel conduit having a first end and a second end, the first end coupled with a second opening on the surface of the plate and the second end coupled with the flavor vessel.

6. The system of claim 1, further comprising a pump, a flavor vessel, a first flavor vessel conduit and a second flavor vessel conduit, each flavor vessel conduit having a first end and a second end, the first end of the first flavor vessel conduit coupled with a second opening on the top surface of the plate, the second end of the first flavor vessel conduit coupled with a first opening of the pump, the first end of the second flavor vessel conduit coupled with a second opening of the pump and the second end of the second flavor vessel conduit coupled with an opening of the flavor vessel.

7. A system for rehydrating a food item with steam, the system comprising:
a housing;
a pressurized moisture source having an outlet, the pressurized moisture source comprising an enclosed vessel within which a liquid is pressurized for release through the outlet;
a plate having a top surface, a bottom surface and an opening traversing between the top surface and the bottom surface;
a casing coupled with the top surface of the plate and having a pivot point;
a conduit having a first end and a second end, the first end coupled with the opening at the top surface of the plate and the second end coupled with the outlet of the pressurized moisture source; and
an actuator coupled with the casing on a first end and the housing at a second end, the actuator configured to move the casing from a first position to a second position by rotation about the pivot point, the first position to flow of moisture from the pressurized moisture source towards the plate the second position to idle flow of moisture from the pressurized moisture source.

8. The system of claim 7, wherein the pressurized moisture source is a pressurized container holding water.

9. The system of claim 8, wherein the plate is a food grade material.

10. The system of claim 7, wherein the bottom surface includes a seal proximate around a perimeter of the plate.

11. The system of claim 7, further comprising a flavor vessel, and a flavor vessel conduit having a first end and a second end, the first end coupled with a second opening on the surface of the plate and the second end coupled with the flavor vessel.

12. The system of claim 7, further comprising a pump, a flavor vessel, a first flavor vessel conduit and a second flavor vessel conduit, each flavor vessel conduit having a first end and a second end, the first end of the first flavor vessel conduit coupled with a second opening on the top surface of the plate, the second end of the first flavor vessel conduit coupled with a first opening of the pump, the first end of the second flavor vessel conduit coupled with a second opening of the pump and the second end of the second flavor vessel conduit coupled with an opening of the flavor vessel.
